(19) United States
(12) Patent Application Publication
(10) Pub. No.: US 2023/0017032 A1
(43) Pub. Date: Jan. 19, 2023

(54) CO2 CONVERSION WITH METAL SULFIDE NANOPARTICLES

(71) Applicant: The Regents of the University of Michigan, Ann Arbor, MI (US)

(72) Inventors: Zetian Mi, Ann Arbor, MI (US); Wan Jae Dong, Ann Arbor, MI (US)

(21) Appl. No.: 17/853,007

(22) Filed: Jun. 29, 2022

Related U.S. Application Data
(60) Provisional application No. 63/216,936, filed on Jun. 30, 2021.

(51) Int. Cl. C25B 3/26; C25B 11/087; C25B 9/19; C25B 9/65; C25B 9/50; C25B 11/059

(52) U.S. Cl. CPC C25B 3/26; C25B 11/087; C25B 9/19; C25B 9/65; C25B 9/50; C25B 11/059

(57) ABSTRACT

A device for catalytic conversion of carbon dioxide (CO₂) includes a substrate having a surface, an array of conductive projections supported by the substrate and extending outward from the surface of the substrate, each conductive projection of the array of conductive projections having a semiconductor composition, and a plurality of nanoparticles disposed over the array of conductive projections, each nanoparticle of the plurality of nanoparticles being configured for the catalytic conversion of carbon dioxide (CO₂). Each nanoparticle of the plurality of nanoparticles includes a metal sulfide, the metal sulfide including a d-block metal.

### CROSS-REFERENCE TO RELATED APPLICATION

This application claims the benefit of U.S. provisional application entitled “CO₂ Conversion with Metal Sulfide Nanoparticles,” filed Jun. 30, 2021, and assigned Ser. No. 63/216,936, the entire disclosure of which is hereby expressly incorporated by reference.

### BACKGROUND OF THE DISCLOSURE

### Field of the Disclosure

The disclosure relates generally to photoelectrochemical and other chemical conversion of carbon dioxide (CO₂).

### Brief Description of Related Technology

Among a vast variety of CO₂ reduction products, formic acid (HCOOH) is an energy-dense liquid fuel and very useful chemical in industry. The conversion to formic acid requires only a two-electron transfer, and therefore is kinetically favorable to produce relative to other complex products, such as CH₃OH, CH₄, C₂H₄, and C₂H₅OH. However, efficient and selective photoelectrochemical reduction of CO₂ to HCOOH with large turnover frequency (TOF) at low overpotential still remains a substantial challenge due to the chemical inertness of CO₂, the complex reaction network of CO₂ conversion, and the severe competition of hydrogen evolution.

Photocathodes having a semiconductor light absorber and electrocatalysts have been used for artificial photosynthesis of HCOOH from CO₂ reduction. Various electrocatalysts, such as molecular complexes, enzymes, and metals (e.g., Pb, In, Cu, and Sn) in conjunction with various semiconductors, have been developed for CO₂ to HCOOH transformation. In spite of some notable achievements, the efficiency of these photoelectrodes remains far from any practical application due to the low sunlight-harvesting efficiency, sluggish charge carrier extraction, low atom-utilization efficiency, and ineffective CO₂ activation.

Photoelectrochemical (PEC) reduction of carbon dioxide (CO₂) with water (H₂O) into fuels and chemicals, so-called artificial photosynthesis, is a promising strategy for storing intermittent solar energy and alleviating anthropogenic carbon emissions. For the PEC CO₂ reduction reaction (RR), the first step is the absorption of incident photons and the generation of electron-hole pairs in semiconductors. Then, the photogenerated electrons migrate to the surface and reduce CO₂ into chemicals. During each step, a large number of electrons may be consumed through recombination. Therefore, effective strategies to prevent recombination are highly desirable to achieve breakthrough advances. Up to now, a wide range of semiconductors such as Si, III-V, and oxide materials have been demonstrated for PEC CO₂ reduction. However, oxide materials generally suffer from inefficient solar light absorption and limited charge carrier mobility. High-performance photoelectrodes have been obtained by III-V compound semiconductors but at a high cost. In contrast, Si is earth-abundant and has a suitable bandgap (1.1 eV) for absorbing a large portion of the solar spectrum as well as excellent charge carrier mobility, thus being one of the most attractive candidates for photoelectrodes. However, Si intrinsically has poor catalytic activity. So, surface cocatalysts have been used to overcome the sluggish kinetics.

To date, several noble metals such as Au, Ag and their alloys have been reported as cocatalysts on Si photocathodes. Such expensive noble metals hinder scalable production. In order to replace the noble metals with inexpensive catalysts, Cu has been investigated. The Cu catalysts, however, exhibited low selectivity because a strong bonding between Cu and intermediates prevents the desorption of single carbon products (HCOOH or CO) but converts them to various other products. These problems can be potentially addressed by modification of Cu via alloying or forming heterogeneous catalysts. However, the utilization of cocatalysts/Si as photocathodes still remains a grand challenge, due to the inefficient solar light-harvesting of planar Si, and limited surface area for the loading of the cocatalysts. Most importantly, Si photocathodes suffer from poor stability in aqueous solution.

Recently, defect-free GaN nanowires have been grown on planar silicon wafers, enabling highly stable and efficient PEC CO₂ reduction as well as water splitting. The defect-free and N-rich GaN nanowires improved the stability and charge carrier extraction from the silicon substrate. What is more, the unique geometry of the GaN nanowires enhanced light-harvesting by suppressing the Fresnel reflection and significantly promoting catalytic activity by increasing the loading of the cocatalysts, thereby presenting an ideal architecture for PEC CO₂ reduction.

Until now, most studies have focused on the development of high-performing PEC photocathodes through the modification of physical and/or chemical structures. However, considering the practical applications, compatibility with real CO₂ gas may be problematic. Flue gas from industry contains impurities such as H₂, CO, hydrocarbons, nitrogen, and sulfur compounds. Especially, the CO₂ gas (about 8 percent of global CO₂ emissions) emitted by the steel industry each year contains 0.3˜0.9% of hydrogen sulfide (H₂S), and this small amount of H₂S is known to rapidly poison the catalysts. As a result, further purification steps of the CO₂ gas are implemented to obtain the catalytic activity, thereby leading to additional costs.

### SUMMARY OF THE DISCLOSURE

In accordance with one aspect of the disclosure, a device for catalytic conversion of carbon dioxide (CO₂) includes a substrate having a surface, an array of conductive projections supported by the substrate and extending outward from the surface of the substrate, each conductive projection of the array of conductive projections having a semiconductor composition, and a plurality of nanoparticles disposed over the array of conductive projections, each nanoparticle of the plurality of nanoparticles being configured for the catalytic conversion of carbon dioxide (CO₂). Each nanoparticle of the plurality of nanoparticles includes a metal sulfide, the metal sulfide including a d-block metal.

In accordance with another aspect of the disclosure, a photocathode for a photoelectrochemical cell includes a substrate including a semiconductor material, the semiconductor material being doped to generate charge carriers upon solar illumination, an array of nanowires supported by the substrate, each nanowire of the array of nanowires being configured to extract the charge carriers from the substrate, each nanowire of the array of nanowires including gallium nitride, and a plurality of nanoparticles distributed across each nanowire of the array of nanowires, each nanoparticle of the plurality of nanoparticles being configured for the catalytic conversion of carbon dioxide (CO₂) in the photoelectrochemical cell into formic acid. Each nanoparticle of the plurality of nanoparticles includes a metal sulfide, the metal sulfide including a d-block metal.

In accordance with yet another aspect of the disclosure, a method of fabricating a device for catalytic conversion of carbon dioxide (CO₂) includes growing an array of conductive projections on a semiconductor substrate, each conductive projection of the array of conductive projections having a semiconductor composition, depositing a plurality of nanoparticles across each conductive projection of the array of conductive projections, each nanoparticle of the plurality of nanoparticles having a metallic composition for the catalytic conversion of carbon dioxide (CO₂), the metal composition including a d-block metal, and implementing an electrochemical procedure that immerses the array of conductive projections in an electrolyte including hydrogen sulfide (H₂S) to transform the metallic composition of each nanoparticle of the plurality of nanoparticles such that each nanoparticle of the plurality of nanoparticles includes a metal sulfide.

In connection with any one of the aforementioned aspects, the devices and/or methods described herein may alternatively or additionally include or involve any combination of one or more of the following aspects or features. The metal sulfide includes copper sulfide. The metal sulfide is selected from the group consisting of copper sulfide, silver sulfide, gold sulfide, zinc sulfide, and combinations thereof. Each conductive projection of the array of conductive projections is coated with respective nanoparticles of the plurality of nanoparticles. The respective nanoparticles of the plurality of nanoparticles do not uniformly cover each conductive projection of the array of conductive projections. The substrate includes a semiconductor material, and the semiconductor material is doped to define a junction to generate charge carriers upon absorption of solar radiation. Each conductive projection of the array of conductive projections includes a nanowire configured to extract the charge carriers generated in the substrate. The substrate includes silicon. The semiconductor composition includes gallium nitride. The catalytic conversion occurs in a thermochemical cell. An electrochemical system includes a working electrode configured in accordance with any of the devices disclosed herein, and further includes a counter electrode, an electrolyte in which the working and counter electrodes are immersed, and a voltage source that applies a bias voltage between the working and counter electrodes. The bias voltage is set to a level for conversion of CO₂ into formic acid at the working electrode. The electrolyte includes hydrogen sulfide (H₂S). The metal sulfide includes copper sulfide. A photoelectrochemical system includes a working photocathode configured in accordance with any of the photocathodes disclosed herein, and further includes a counter electrode, an electrolyte in which the working photocathode and the counter electrode are immersed, and a voltage source that applies a bias voltage between the working photocathode and the counter electrode. The bias voltage is set to a level for conversion of CO₂ into formic acid at the working photocathode. The electrolyte includes hydrogen sulfide (H₂S). The electrolyte further includes carbon dioxide (CO₂). Forming the array of conductive projections includes growing an array of nanowires on the semiconductor substrate, each nanowire of the array of nanowires having a semiconductor composition for the catalytic conversion of carbon dioxide (CO₂). Growing the array of nanowires includes implementing a molecular beam epitaxy (MBE) procedure under nitrogen-rich conditions. Depositing the plurality of nanoparticles includes implementing a thermal evaporation procedure to deposit copper nanoparticles on the array of conductive projections. Implementing the electrochemical procedure includes conducting a photoelectrochemical CO₂ reduction reaction. Implementing the electrochemical procedure includes dissolving carbon dioxide (CO₂) and hydrogen sulfide (H₂S) into a KHCO₃ electrolyte. The metallic composition includes copper such that the metal sulfide includes copper sulfide.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 depicts (a) a schematic view of a method of fabricating a device for catalytic conversion of carbon dioxide (CO₂) in which metal nanoparticles are transformed into metal sulfide nanoparticles in accordance with one example, as well as (b) a scanning electron microscopy (SEM) image of GaN nanowires in accordance with one example, (c) an SEM image of copper nanoparticles on the GaN nanowires in accordance with one example, and (d) an SEM image of copper sulfide (CuS) nanoparticles on the GaN nanowires in accordance with one example.

FIG. 2 depicts (a) a transmission electrode microscope (TEM) image of CuS nanoparticles on GaN nanowires supported by a silicon substrate in accordance with one example, as well as (b) elemental maps for the CuS nanoparticles, GaN nanowires, and silicon substrate, (c) a high-resolution TEM image and electron diffraction pattern of a CuS/GaN interface, (d) a Fourier-filtered image of the interface by masking GaN (002), and (e) a Fourier-filtered image of the interface by masking CuS.

FIG. 3 depicts graphical plots of x-ray photoelectron spectroscopy (XPS) spectra of (a) Ga 3d, (b) N 1s, (c) Cu 2p_{3/2}, and (d) S 2p for GaN/Si, Cu/GaN/Si, and CuS/GaN/Si combinations.

FIG. 4 depicts (a) a schematic view of photoelectrochemical CO₂ reduction and an energy diagram in connection with a CuS/GaN/Si photocathode in accordance with one example, as well as (b) a graphical plot of LSV curves, (c) a graphical plot of Faradaic efficiencies FE_{HCOOH}, (d) a graphical plot of current density j_{HCOOH} of Cu/Si, CuS/Si, Cu/GaN/Si, and CuS/GaN/Si in CO₂ or CO₂+H₂S-purged 0.1 M KHCO₃ electrolyte, and (e) a graphical comparison of PEC CO₂ reduction reaction (RR) activity of a CuS/GaN/Si device in a CO₂+H₂S and CO₂-purged electrolyte, in which the CuS/GaN/Si device was prepared in CO₂+H₂S electrolyte and then transferred to a CO₂-purged electrolyte for the measurement.

FIG. 5 is a graphical plot of current density and Faradaic efficiency of a CuS/GaN/Si photoelectrode measured in CO₂+H₂S-purged 0.1 M KHCO₃ electrolyte at a bias voltage of −0.8 and −1.0 V_{RHE} for 10 hours in accordance with one example.

FIG. 6 is a schematic view and block diagram of an electrochemical system having a working electrode with a nanowire-nanoparticle architecture for catalytic conversion of carbon dioxide (CO₂) in accordance with one example.

FIG. 7 is a flow diagram of a method of fabricating a device (e.g., a photocathode) for catalytic conversion of carbon dioxide (CO₂) for catalytic conversion of CO₂ in accordance with one example.

The embodiments of the disclosed devices, systems, and methods may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION OF THE DISCLOSURE

Electrodes of photoelectrochemical and other chemical cells having a conductive projection (e.g., nanowire) array with nanoparticles for conversion (e.g., reduction) of carbon dioxide (CO₂) into, e.g., formic acid, are described. Methods of fabricating photocathodes and other electrodes for use in photoelectrochemical and other chemical systems are also described. The conductive projection (e.g., nanowire) array has a semiconductor composition. The nanoparticles are configured for catalytic conversion of carbon dioxide (CO₂). As described herein, the nanoparticles include a metal sulfide such as copper sulfide (CuS). The compositions of the conductive projections (e.g., nanowires) and nanoparticles together provide a useful catalyst interface for CO₂ reduction.

The disclosed devices and systems maintain their catalytic activities when processing an impurity-containing CO₂ mixture gas. For instance, the disclosed devices and systems are capable of the PEC conversion of H₂S-containing CO₂ mixture gas into value-added chemicals such as formic acid.

Described herein are photocathodes and other devices and systems having metal sulfide (e.g., CuS) coated conductive projections (e.g., GaN nanowires) on a semiconductor (e.g., silicon) wafer or other substrate that are highly efficient for reducing H₂S-containing CO₂ mixture gas to HCOOH. Examples of Cu/GaN/Si devices were fabricated on Si wafers by combining thermal evaporation of Cu nanoparticles with molecular beam epitaxy of GaN nanowires.

When PEC CO₂ reduction was carried out in a CO₂ and H₂S mixture gas-purged aqueous electrolyte, the Cu nanoparticles were spontaneously transformed to CuS nanoparticles. The CuS/GaN/Si devices exhibited superior Faradaic efficiency (FE_{HCOOH}) of 70.2% at −1.0 V_{RHE} compared to other photoelectrodes of Cu/Si, CuS/Si, and Cu/GaN/Si. Consequently, the CuS/GaN/Si devices achieved a high partial current density of HCOOH (7.07 mA/cm2), which is nearly 5 times higher than that of a device having CuS on silicon (i.e., CuS/Si). This is the first observation that H₂S impurities, commonly thought to be detrimental to the CO₂ reduction reaction, significantly enhance the PEC activity for HCOOH production, which is further explained by the synergistic effects of the GaN nanowire scaffolding, CuS nanoparticle cocatalysts, and H₂S. Photoelectrodes and other devices and systems with the metal sulfide catalyst arrangement described herein may thus achieve high efficiency reduction of real CO₂ gas despite the presence of various impurities.

The metal sulfide nanoparticles are supported by an architecture including a conductive projection (e.g., nanowire) array. One-dimensional (1-D) nanostructured metal nitrides, such as Gallium nitride (GaN) nanowires (GaN nanowires), are useful in solar fuels production and capable of being grown via molecular beam epitaxy (MBE) defect-free on planar silicon. The heterostructure of the GaN nanowires presents a large surface-to-volume ratio, which is beneficial for sunlight harvesting and catalyst loading with a dramatically reduced amount, but high-density, of catalytic centers. Furthermore, the defect-free structure and high charge carrier mobility of GaN nanowires lead to charge carrier extraction from the silicon substrate. The electronic properties of gallium nitride are useful for activating the stable carbon dioxide molecule, thereby presenting a useful platform for supporting nanoparticles to construct an effective nanoarchitecture for solar-driven CO₂ conversion.

In some cases, the nanowires (e.g., GaN nanowires) are disposed on a planar semiconductor substrate (e.g., silicon) to provide a useful scaffold for loading Cu and/or other nanoparticles to construct a productive architecture (e.g., nanoarchitecture) for CO₂ conversion. The disclosed architectures may, in some cases, be free of noble metals. Nonetheless, high-efficiency sunlight collection is achieved via high-density active sites with a superior nanoparticle (e.g., a CuS nanoparticle) atom-utilization efficiency, as well as effective charge carrier extraction.

Although described herein in connection with electrodes having GaN-based nanowire arrays for PEC CO₂ reduction, the disclosed electrodes are not limited to PEC reduction or GaN-based or other nanowires. A wide variety of types of chemical cells may benefit from use of the conductive projection (e.g., nanowire)-nanoparticle interface, including, for instance, electrochemical cells and thermochemical cells. Moreover, the nature, construction, configuration, characteristics, shape, and other aspects of the conductive projections, as well as the structures on or to which the conductive projections (e.g., nanowires) and/or nanoparticles are deposited, may vary. The disclosed electrodes, systems, and methods may also be directed to CO₂ reduction products other than or in addition to formic acid, such as CO, CH₃OH, CH₄, C₂H₄, C₂H₅OH, and C₂H₆.

Although described herein in connection with CuS nanoparticles, the disclosed devices, systems, and methods may use other metal sulfides. For example, silver sulfide (AgS), gold sulfide (AuS), and zinc sulfide (ZnS) may be used. The metal sulfide may alternatively or additionally include a d-block metal other than Cu, Au, Ag, and Zn. D-block metals include the elements in groups 3-12 of the periodic table.

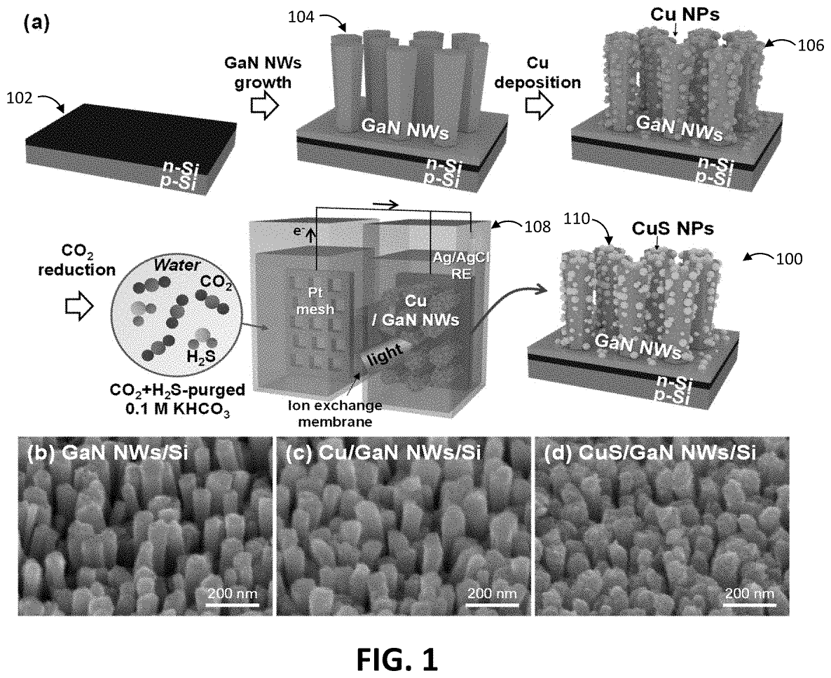

FIG. 1 depicts the fabrication of a device 100 for catalytic conversion of carbon dioxide in accordance with one example. In this case, the device is or includes a Cu/GaN/Si photocathode fabricated via plasma-assisted molecular beam epitaxy (MBE) growth of GaN nanowires 102 on a n+-p silicon substrate 104, followed by thermal evaporation of Cu nanoparticles 106, as shown in Part (a) of FIG. 1. Then, CO₂ reduction reaction is performed using the Cu/GaN/Si combination as a photoelectrode in a CO₂+H₂S-purged 0.1 M KHCO₃ electrolyte 108 at −0.8 V_{RHE} under light illumination (e.g., 100 mW/cm²). During the reaction, dissolved H₂S participated in transforming the Cu nanoparticles 106 into CuS nanoparticles 110. As described herein, the spontaneously formed CuS nanoparticles 110 improved the selectivity of converting CO₂ to HCOOH.

As shown in Part (b) of FIG. 1, scanning electron microscopy (SEM) characterization showed that the GaN nanowires are vertically oriented on the planar silicon substrate. The lengths of GaN nanowires may be about 400 nm with diameters of about 50 nm, but other sizes and shapes may be used. After the deposition of the Cu nanoparticles, the morphology of GaN nanowires may not change, as shown in Part (c) of FIG. 1. After the CO₂ reduction reaction in the CO₂+H₂S-purged electrolyte, however, the surface morphology was roughened, as shown in Part (d) of FIG. 1.

To clarify whether the morphology of GaN nanowires was changed, the SEM images of the GaN nanowires before and after the CO₂ reduction reaction in the CO₂+H₂S-purged electrolyte were compared. There was no change in the morphology of the GaN nanowires, meaning that the GaN nanowires were chemically stable against H₂S in the electrolyte. Moreover, energy dispersive X-ray spectroscopy showed that no change in atomic compositions of the GaN nanowires after the CO₂ reduction reaction. Meanwhile, a new characteristic sulfur peak was detected in the Cu/GaN/Si combination after the CO₂ reduction reaction, indicating that the Cu nanoparticles were transformed to CuS nanoparticles.

In this example, because the deposition of Cu nanoparticles is performed in the surface-normal direction, a relatively large number of the Cu nanoparticles are decorated or otherwise disposed on the upper part of the GaN nanowires. Electron energy loss spectroscopy (EELS) mapping further revealed the presence of Cu on the surface of GaN nanowires at the positions corresponding to particle-like features in the TEM image. In the high-resolution TEM image, lattice fringes were observed with d-spacings of 0.21 nm and 0.26 nm, which are attributed to Cu (111) and GaN (002) planes, respectively. To clarify the distribution of the Cu nanoparticles, Fourier-filtering was performed by masking Cu (111). The Fourier-filtered image and electron diffraction pattern confirmed that the Cu nanoparticles were coated on the GaN nanowires and had a size of about 3 to about 6 nm.

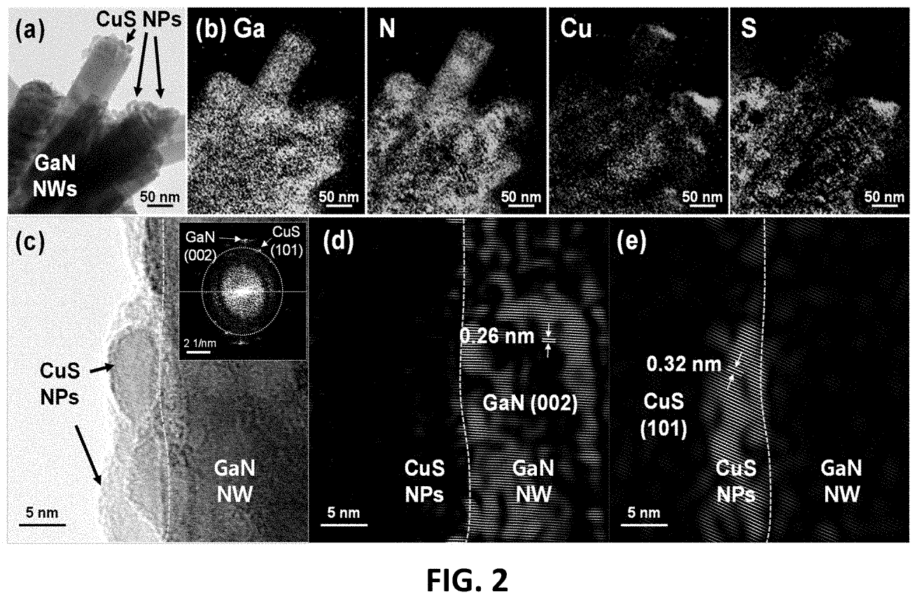

After the CO₂ reduction reaction in the CO₂+H₂S-purged electrolyte, the nanoparticles still remained on the GaN nanowires, as shown in Part (a) of FIG. 2. Moreover, clear signals from EELS elemental mapping of Ga, N, Cu, and S confirmed CuS nanoparticles coating the GaN nanowires, as shown in Part (b) of FIG. 2. In contrast to the uniform distribution of Ga and N in the GaN nanowires, Cu and S, which originated from the CuS nanoparticles, showed bright and dark contrast. This means that the CuS nanoparticles were decorated on the GaN nanowires, but did not uniformly cover the entire surface. In the high-resolution TEM image, the CuS nanoparticles had a size of about 4 nm to about 7 nm on the GaN nanowires, as shown in Part (c) of FIG. 2. Part (d) of FIG. 2 are Fourier filtered images by masking GaN (200) that exhibit d-spacing of 0.26 nm in the growth direction of the GaN nanowires, representing the single-crystal GaN nanowires grown on the Si (100) substrate. This defect-free feature is useful for charge carrier transport. The TEM image masked by CuS (101) showed the polycrystalline structure of CuS (101) with a lattice spacing of 0.32 nm providing evidence of the CuS nanoparticles, as shown in Part (e) of FIG. 2. The clear interface between the GaN nanowires and the CuS nanoparticles means that there is no chemical reaction between them during the reaction. Moreover, X-ray diffraction (XRD) measurements were taken to verify the CuS planes on the GaN nanowires. However, only the GaN (002) peak was detected without the Cu or CuS peak. This is because the grain size of Cu or CuS nanoparticles (<7 nm) is too small to be detected by XRD. Instead, a relatively thick Cu 50 nm film was formed on a glass substrate and immersed in the CO₂+H₂S-purged 0.1 M KHCO₃. The Cu film exhibited a Cu (111) peak while a new peak of CuS (111) was observed after the reaction with H₂S. The XRD result implies that the CuS compound could be formed by the reaction between Cu and H₂S in the electrolyte.

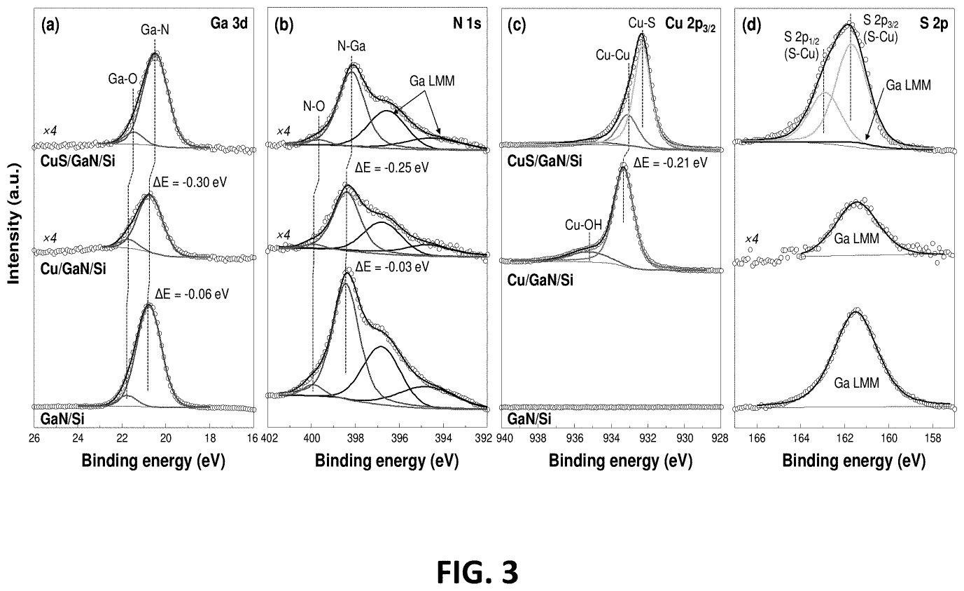

To investigate the surface chemical compositions of the electrodes, X-ray photoelectron spectroscopy (XPS) was carried out. The Ga 3d XPS spectra were deconvoluted with a major peak of Ga—N bond (20.8 eV) and a minor peak of Ga—O bond (21.8 eV), indicating the GaN phase (see Part (a) of FIG. 3). After depositing the Cu or CuS nanoparticles, the intensity of the Ga 3d XPS spectra decreased because the nanoparticles screen the photoelectrons emitted from the GaN nanowires. In N 1s XPS spectra, the photoelectrons emitted from N—Ga (398.4 eV) and N—O (399.9 eV) bonds were detected with Ga LMM Auger electrons (see Part (b) of FIG. 3). Although the intensity of N 1s from the GaN nanowires decreased after coating of Cu or Cu nanoparticles due to screening of photoelectrons, the bonding states were nearly identical. This means that the composition of the GaN nanowires did not change after the deposition of the Cu nanoparticles or during the CO₂ reduction reaction in the CO₂+H₂S-purged electrolyte. For elucidation of the bonding states of Cu species, deconvolution of Cu 2p_{3/2} XPS spectra was carried out with Cu—Cu (933.3 eV), Cu—OH (935.2 eV), Cu—S(932.3 eV) bonds (see Part (c) of FIG. 3). The GaN nanowires did not show Cu 2p_{3/2} XPS spectrum and the Cu/GaN/Si combination exhibited a strong metallic Cu—Cu bond with a small Cu—OH bond. However, the CuS/GaN/Si combination showed a very intense Cu—S peak and a relatively small Cu—Cu peak. The coexistence of the metallic Cu—Cu bonds and Cu—S bond in Cu 2p_{3/2} XPS spectrum implies that the CuS nanoparticles were a slightly reduced form of CuS and Cu phases. GaN/Si and Cu/GaN/Si did not show S 2p in the XPS spectra, but CuS/GaN/Si showed clear S—Cu bonds, indicating the transformation of Cu to CuS nanoparticles (see Part (d) of FIG. 3). From the Cu 2p_{3/2} and S 2p XPS spectra, a ratio of Cu:S=22:17 was calculated, corresponding to Cu_{1.3}S nanoparticles. The oxidation state of Cu and Cu nanoparticles was characterized by Auger Cu LMM spectra. When Cu was transformed to CuS nanoparticles, the intensity of the Cu0 peak was significantly reduced and the intensity of Cu⁺ and Cu²⁺ peaks increased, indicating that metallic Cu was converted to Cu₂S or CuS phases. The calculated oxidation state of Cu nanoparticles was 0.6 and that of CuS nanoparticles was 1.3. Assuming that the oxidation state of Cu originates only from the Cu—S bond, the Cu:S ratio of CuS nanoparticles becomes 1.5:1. From the XPS analysis, CuₓS nanoparticles (1.3≤x≤1.5) have a mixed-valence of Cu. It is worth noting that the Ga 3d, N 1s, and Cu 2p_{3/2} XPS spectra of the CuS/GaN/Si combination exhibited a shift compared to those of GaN/Si or Cu/GaN/Si. It suggests the redistribution of the electron density and a strong interaction between GaN nanowires and CuS nanoparticles. The driving force for electron redistribution is either a difference in electronegativity or a difference in the number of electrons populated in valence bands.

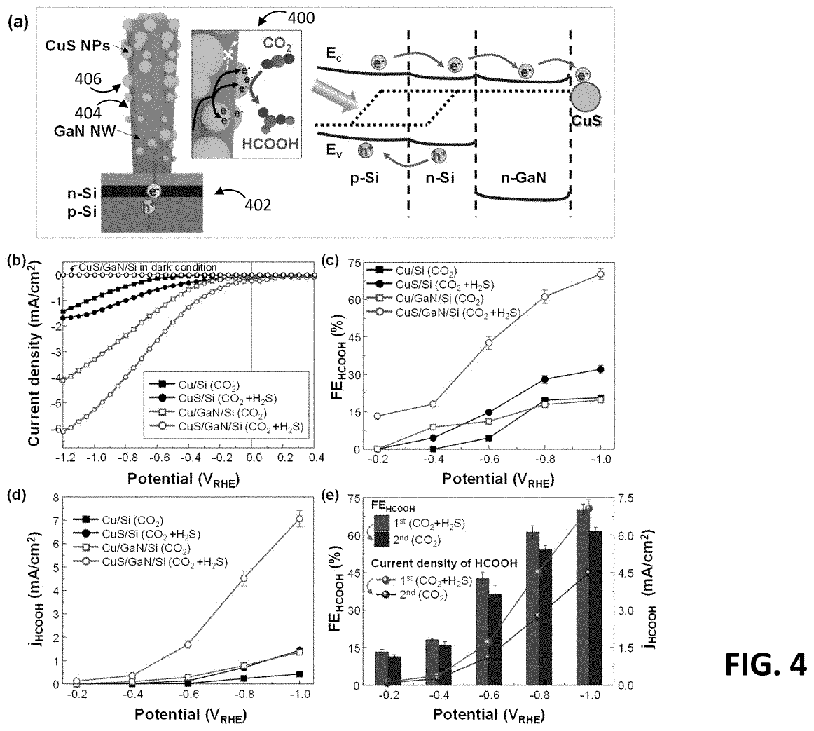

The performance of the above-described examples in a photoelectrochemical CO₂ reduction reaction 400 is now described in connection with FIG. 4.

A n⁺-p Si substrate 402 with a narrow bandgap (about 1.1 eV) was photoexcited by solar irradiation to generate electron-hole pairs for the reaction (see Part (a) of FIG. 4). The light absorption of GaN nanowires 404 is relatively negligible due to their large bandgap (about 3.4 eV). However, the GaN nanowires 404 improve the light absorption of the planar Si substrate 402 by reducing the Fresnel reflection because the geometry of the nanowires 404 is useful for matching the refractive indices between the air and the Si substrate 402. Moreover, the GaN nanowires 404 function as a useful geometric modifier to load cocatalysts 406 (e.g., CuS nanoparticles) for enhancing the catalytic reaction 400. In one example, the electrochemical surface area of the CuS nanoparticles 406 on the GaN nanowires 404 was about 16.8 times larger than a planar Si wafer. In this architecture, the light-harvesting and catalytic behavior is spatially decoupled, enabling the optical and catalytic properties to be rationally manipulated to achieve optimum performance. As shown in the energy diagram of the electrode (Part (a) of FIG. 4), the electron transport is also feasible without an energy barrier between the GaN nanowires 404 and the Si substrate 402 because the GaN nanowires 404 and the Si substrate 402 are heavily n-type doped.

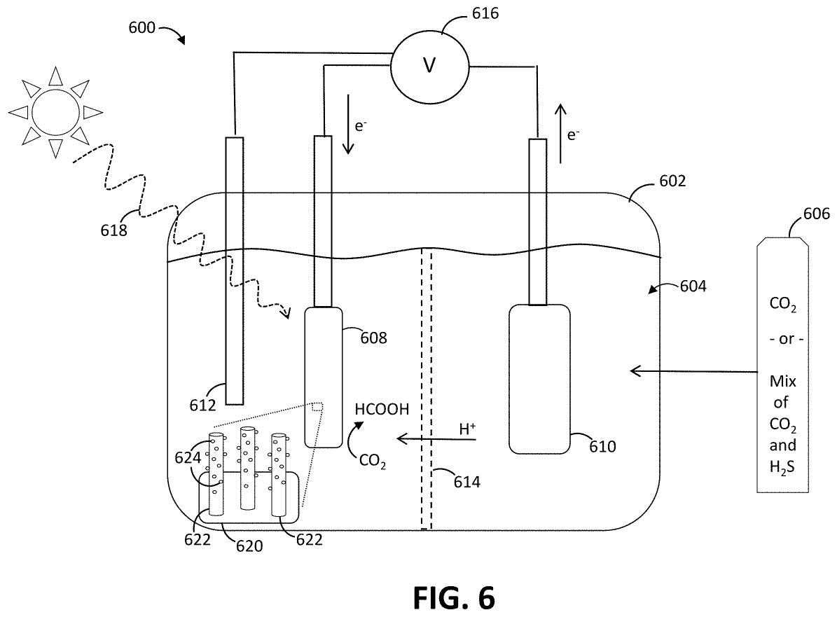

Linear sweep voltammetry (LSV) measurements were conducted to study the PEC CO₂ reduction reaction performance of the planar n⁺-p Si, a Cu/Si combination, a CuS/Si combination, a GaN/Si combination, a Cu/GaN/Si combination, and a CuS/GaN/Si in accordance with one example, in CO₂- or CO₂+H₂S-purged 0.1 M KHCO₃ under one-sun illumination (100 mW/cm²) using a three-electrode configuration, an example of which is shown in FIG. 6. The photocurrent of pristine Si was essentially negligible even at a high negative potential of −1.2 V_{RHE}. After deposition of a Cu cocatalyst on the Si substrate (Cu/Si), the reductive photocurrent density was measured as −0.9 mA/cm² at −1.0 V_{RHE} and the onset potential was −0.4 V_{RHE} in CO₂-purged electrolyte, as shown in Part (b) of FIG. 4. After the reaction in CO₂+H₂S-purged electrolyte, the CuS/Si combination showed further enhanced performance, resulting in a photocurrent density of −1.5 mA/cm² at −1.0 V_{RHE} and positive shift of onset potential to 0.0 V_{RHE}. Strikingly, the GaN nanowires grown on Si substrate (GaN/Si) showed a substantial improvement in both onset potential (0.2 V_{RHE}) as well as photocurrent density (−2.7 mA/cm² at −1.0 V_{RHE}) compared to those of Si, Cu/Si and CuS/Si because of the enhanced light absorption, effective charge carrier extraction, and reduced surface recombination. Furthermore, the photocurrent density was improved to −3.3 and −5.3 mA/cm² at −1.0 V_{RHE} for Cu/GaN/Si and CuS/GaN/Si, respectively. The CuS/GaN/Si example, spontaneously formed during the reduction reaction of CO₂+H₂S mixture gas, showed the best photocurrent density and onset potential. The increased photocurrent density of CuS/GaN/Si over Cu/GaN/Si is attributed to both the enhanced catalytic activity and the increased optical transmittance (OT) of the CuS nanoparticles because the CuS nanoparticles inherently have better OT than metallic Cu. The CuS nanoparticles acted as efficient light-trapping structures on the GaN/Si photocathode and increased the light absorption by about 10% in the visible wavelength of about 400 nm to about 700 nm. In addition, the CuS/GaN/Si example showed a smaller impedance arc of the second semicircle in the Nyquist impedance plot than the Cu/GaN/Si combination, meaning that sulfur species on the Cu surface lowered the charge transfer resistance. The CuS/GaN/Si example exhibited negligible activity in dark conditions due to the absence of the photogenerated charge carriers, indicating that solar energy was the driving force for the PEC reaction.

Faradaic efficiencies of the Si, Cu/Si, CuS/Si, GaN/Si, Cu/GaN/Si, and CuS/GaN/Si photocathodes were characterized at different applied potentials from −0.2 to −1.0 V_{RHE}. Planar Si primarily produced hydrogen with only a trace amount of CO (FECO=6.5% at −1.0 V_{RHE}). Deposition of a Cu cocatalyst on the Si substrate (Cu/Si) began to generate HCOOH at −0.4 V_{RHE} and showed the maximum FE_{HCOOH} of 20.7% in CO₂-purged 0.1 M KHCO₃ at −1.0 V_{RHE}(see Part (c) of FIG. 4). When the spontaneously formed CuS nanoparticles were decorated on the Si photocathode (CuS/Si), the onset potential for HCOOH production positively shifted to −0.4 V_{RHE} accompanied with an increase in the maximum FE_{HCOOH} to 32.0% in CO₂+H₂S-purged electrolyte. The sulfur species on Cu surfaces can promote the formation of an HCOO* intermediate while *COOH formation is thermodynamically less favorable. Both effects of the favorable formation of HCOO* and the less favorable formation of *COOH lead to suppressed production of CO and improved FE_{HCOOH} on CuS as compared to a Cu surface.

The GaN/Si combination without a cocatalyst showed HCOOH production (FE_{HCOOH}=12.8% at −1.0 V_{RHE}), indicating that GaN nanowires are catalytically more active than Si toward reduction of CO₂+H₂S mixture gas. After the deposition of Cu nanoparticles, the Cu/GaN/Si combination exhibited a slightly increased selectivity (FE_{HCOOH}=19.6% at −1.0 V_{RHE}). Impressively, the CuS/GaN/Si combination greatly improved FE_{HCOOH} as high as 70.2% at −1.0 V_{RHE}. There were no other liquid products other than HCOOH. Although FE_{HCOOH} gradually decreased with a positive shift of potential, HCOOH was still produced (FE_{HCOOH}=11.3%) at −0.2 V_{RHE}. At the low potential of −0.2 V_{RHE}, total Faradaic efficiency of CuS nanoparticles (62.8%) was lower than that of Cu nanoparticles (78.2%). The remaining charge balance is likely attributed to the reduction of CuS because it is thermodynamically spontaneous at reduction conditions (e.g., Cu²⁺+2e⁻→Cu, E°=0.34 V). When reducing the impure feedstock, a part of the photocurrent may go towards the reduction of unwanted compounds rather than the production of chemical fuels. Nonetheless, the partial coverage of CuS nanoparticles on the GaN nanowires greatly improved the reaction selectivity, which means that most of the photogenerated electrons moved to the more active sites of the CuS nanoparticles rather than to the exposed surface of GaN nanowires. Because the CuS/GaN/Si example showed the best photocurrent density and the highest FE_{HCOOH} among the tested photoelectrodes, the partial current density of HCOOH (j_{HCOOH}) was also the highest. The maximum j_{HCOOH} of the CuS/GaN/Si example was 7.07 mA/cm² which is about 5 times higher than the Cu/GaN/Si combination measured in CO₂-purged electrolyte (Part (d) of FIG. 4). Thus, the cooperative effect between the GaN nanowires and CuS nanoparticles boosted the conversion rate of CO₂ mixture gas to HCOOH as well as the selectivity. The disclosed devices and systems thus provide for the PEC conversion of CO₂ mixture gas to value-added chemicals.

To confirm whether the CuS cocatalyst, formed via the CO₂+H₂S-purged electrolyte, can maintain its catalytic activities in a CO₂-purged electrolyte, CuS/GaN/Si examples were prepared in CO₂+H₂S-purged electrolytes and transferred to a CO₂-purged electrolyte for the PEC CO₂ reduction reaction (see Part (e) of FIG. 4). The second reaction conducted in the CO₂-purged electrolyte showed slightly decreased FE_{HCOOH}=61.6% and j_{HCOOH}=4.49 mA/cm2 at −1.0 V_{RHE} compared to the first reaction. The decreased FE_{HCOOH} and j_{HCOOH} may be explained by the reduction of CuS to Cu. TEM and XPS characterizations revealed that some portion of the CuS nanoparticles was electrochemically reduced to Cu during the PEC CO2 reduction reaction, resulting in a mixed structure composed of Cu and CuS. However, interestingly, the CuS/GaN/Si example showed relatively higher FE_{HCOOH} and j_{HCOOH} than those of other GaN/Si or Cu/GaN/Si photoelectrodes tested in a CO₂-purged electrolyte. This result indicates that when CuS nanoparticles are formed on GaN nanowires, the catalytic activity is maintained regardless of the gas purged into the electrolyte. Moreover, the reaction kinetic is mainly dominated by the CuS nanoparticles, not by the presence of sulfur species in the electrolyte.

Other catalysts, including Bi and Sn, were tested for converting CO₂+H₂S gas to HCOOH because Bi and Sn catalysts are known materials for the selective production of HCOOH. In a CO₂-purged 0.1 M KHCO₃ solution, Bi and Sn catalysts exhibited high FE_{HCOOH} of 82% and 80% at −0.8 V_{RHE}. However, the Bi and Sn catalysts exhibited drastically degraded selectivity in a CO₂+H₂S-purged 0.1 M KHCO₃ electrolyte, resulting in low FE_{HCOOH} of 41% and 38%, respectively. The reason for the degradation is likely due to sulfur poisoning of the catalysts. On the other hand, interestingly, Cu catalysts improved FE_{HCOOH} from 17% to 58% in CO₂+H₂S-purged electrolyte, indicating that the H₂S impurity mixed in the CO₂ gas can enhance, rather than degrade, the performance of CO₂ reduction reaction.

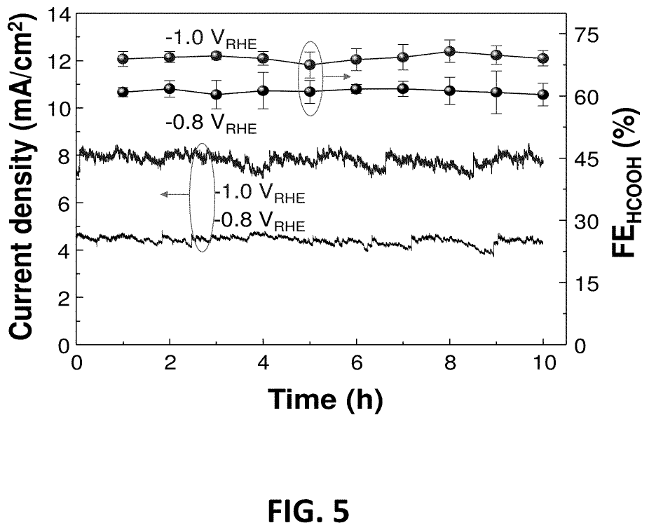

The stability of the CuS/GaN/Si and other photocathodes and devices described herein is a useful factor for practical application. Therefore, the catalytic activity was evaluated for 10 hours at constant potentials of −0.8 and −1.0 V_{RHE} in CO₂+H₂S-purged 0.1 M KHCO₃ (FIG. 5). The gas was bubbled in the solution for the current density measurement to prevent the changing of the pH value, and the electrolyte was replaced every 1 hour of reaction time for FE measurement. The CuS/GaN/Si example exhibited constant current density of about 4.5 and about 7.8 mA/cm² at −0.8 and −1.0 V_{RHE}, respectively. Moreover, the high FE_{HCOOH} of about 60% and about 70% was consistently obtained for 10 hours at −0.8 and −1.0 V_{RHE}, respectively. This means that the CuS/GaN/Si example is a stable photocathode that can continuously produce HCOOH from the H₂S impurity-containing CO₂ gas without degradation.

The examples described above demonstrated a photocathode having CuS nanoparticles and GaN nanowires for conversion of CO₂ mixture gas to HCOOH. CuS/GaN/Si photoelectrodes were fabricated by molecular beam epitaxy growth of GaN nanowires on planar Si substrate, deposition of Cu nanoparticles, followed by transformation to CuS nanoparticles. Cu nanoparticles spontaneously transformed to CuS nanoparticles without additional process during the PEC CO2 reduction in CO2+H2S-purged aqueous electrolyte. This multifunctional architecture allows for efficient solar light harvesting, effective charge carrier transport, and significantly enhanced catalytic active sites. As a result, the CuS/GaN/Si examples showed superior FE_{HCOOH}=70.2% and partial current density of HCOOH=7.07 mA/cm² at −1.0 V_{RHE} compared to other photoelectrodes of Cu/Si, CuS/Si, and Cu/GaN/Si. The photocathode is composed of, or otherwise includes, industry-ready materials (e.g., Si, GaN, and Cu), and presents high activity toward the reduction of impurity-containing CO₂ gas, thus providing a promising route for achieving low-cost and high-efficiency production of solar fuels from real CO₂ gas.

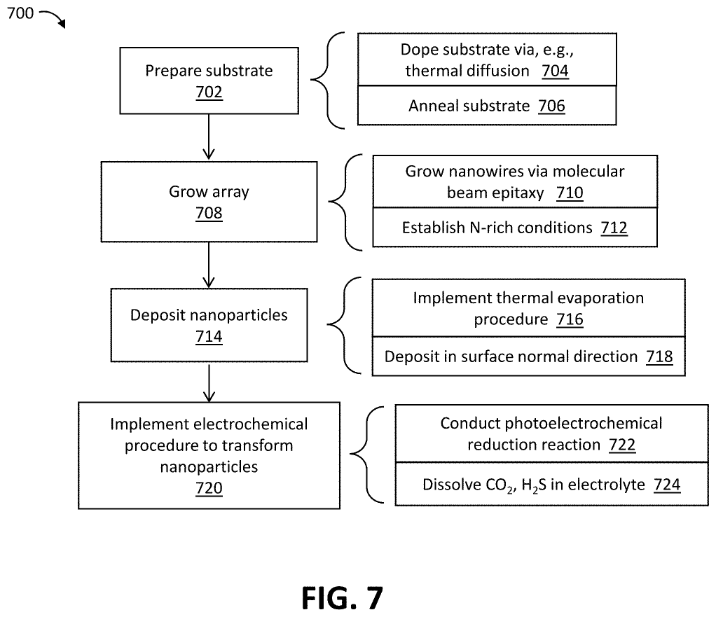

A number of examples of the disclosed devices, systems, and methods are now described in connection with the schematic diagram of FIG. 6 and the flow diagram of FIG. 7.

FIG. 6 depicts a system 600 for reduction of CO₂ into formic acid in accordance with one example. The system 600 may also be configured for alternative or additional reactions, including, for instance, the evolution of H₂. The system 600 may be configured as an electrochemical system. In this example, the electrochemical system 600 is a photoelectrochemical (PEC) system in which solar or other radiation is used to facilitate the CO₂ reduction. The manner in which the PEC system 600 is illuminated may vary. In thermochemical examples, the source of radiation may be replaced by a heat source.

The electrochemical system 600 includes one or more electrochemical cells 602. A single electrochemical cell 602 is shown for ease in illustration and description. The electrochemical cell 602 and other components of the electrochemical system 600 are depicted schematically in FIG. 6 also for ease in illustration. The cell 602 contains an electrolyte solution 604 to which a source 606 of CO₂ is applied. Alternatively, the source 606 provides a CO₂ mixture. The CO₂ mixture may include one or more impurities, such as H₂S. In some cases, the electrolyte solution is saturated with CO₂ and/or H₂S. Potassium bicarbonate KHCO₃ may be used as an electrolyte. Additional or alternative electrolytes may be used. Further details regarding an example of the electrochemical system 600 are provided hereinabove.

The electrochemical cell 602 includes a working electrode 608, a counter electrode 610, and a reference electrode 612, each of which is immersed in the electrolyte 604. The counter electrode 610 may be or include a metal wire or mesh, such as a platinum wire or mesh. The reference electrode 612 may be configured as a reversible hydrogen electrode (RHE). The configuration of the counter and reference electrodes 610, 612 may vary. For example, the counter electrode 610 may be configured as, or otherwise include, a photoanode at which water oxidation (2H₂O [symbol] O2+4e⁻+4H⁺) occurs.

Both reduction of CO₂ and evolution of H₂ may occur at the working electrode 612 as follows:

CO₂ reduction: CO₂+2H⁺+2e⁻ [symbol] CHOOH

H₂ evolution: 2H⁺+2e⁻ [symbol] H₂

To that end, electrons flow from the counter electrode 610 through a circuit path external to the electrochemical cell 602 to reach the working electrode 608. The working and counter electrodes 608, 610 may thus be considered a cathode and an anode, respectively. The competition between reduction of CO₂ and evolution of H₂ may be managed or controlled (e.g., to favor CO₂ reduction) via the composition of the components of the nanoarchitecture and/or the applied voltage, as described herein.

In the example of FIG. 6, the working and counter electrodes are separated from one another by a membrane 614, e.g., a proton-exchange membrane. In some cases, the membrane 614 is configured as, or otherwise includes, a Nafion membrane. The construction, composition, configuration and other characteristics of the membrane 614 may vary.

In this example, the circuit path includes a voltage source 616 of the electrochemical system 600. The voltage source 616 is configured to apply a bias voltage between the working and counter electrodes 608, 610. The bias voltage may be used to establish a ratio of CO₂ reduction to hydrogen (H₂) evolution at the working electrode, as described further below. The circuit path may include additional or alternative components. For example, the circuit path may include a potentiometer in some cases.

In some cases, the working electrode 608 is configured as a photocathode. Light 618, such as solar radiation, may be incident upon the working electrode 608 as shown. The electrochemical cell 602 may thus be considered and configured as a photoelectrochemical cell. In such cases, illumination of the working electrode 608 may cause charge carriers to be generated in the working electrode 608. Electrons that reach the surface of the working electrode 608 may then be used in the CO₂ reduction and/or the H₂ evolution. The photogenerated electrons augment the electrons provided via the current path. The photogenerated holes may move to the counter electrode for the water oxidation. A number of examples of, and further details regarding, photocathodes are provided hereinabove in connection with, for instance, FIGS. 1-5.

The working electrode 608 includes a substrate 620. The substrate 620 of the working electrode 608 may constitute a part of an architecture, or a support structure, of the working electrode 608. The substrate 620 may be uniform or composite. For example, the substrate 620 may include any number of layers or other components. The substrate 620 thus may or may not be monolithic. The shape of the substrate 620 may also vary. For instance, the substrate 620 may or may not be planar or flat.

The substrate 620 of the working electrode 608 may be active (functional) and/or passive (e.g., structural). In the latter case, the substrate 620 may be configured and act solely as a support structure for a catalyst arrangement formed along an exterior surface of the working electrode 608, as described below. Alternatively or additionally, the substrate 620 may be composed of, or otherwise include, a material suitable for the growth or other deposition of the catalyst arrangement of the working electrode 608.

The substrate 620 may include a light absorbing material. The light absorbing material is configured to generate charge carriers upon solar or other illumination. The light absorbing material has a bandgap such that incident light generates charge carriers (electron-hole pairs) within the substrate. Some or all of the substrate 620 may be configured for photogeneration of electron-hole pairs. To that end, the substrate 620 may be composed of, or otherwise include, a semiconductor material. In some cases, the substrate 620 is composed of, or otherwise includes, silicon. For instance, the substrate 620 may be provided as a silicon wafer. The silicon may be doped. In some cases, the substrate 620 is heavily n-type doped, and moderately or lightly p-type doped, to form a junction. The doping arrangement may vary. For example, one or more components of the substrate 620 may be non-doped (intrinsic), or effectively non-doped. The substrate 620 may include alternative or additional layers, including, for instance, support or other structural layers. In other cases, the substrate 620 is not light absorbing. In these and other cases, one or more other components of the photocathode (e.g., nanowires) may be composed of, or otherwise include, a semiconductor material configured to act as a light absorber. Thus, in photoelectrochemical cases, the semiconductor material of the substrate and/or other components supported by the substrate may be configured to generate charge carriers upon absorption of solar (or other) radiation, such that the chemical cell is configured as a photoelectrochemical system.

The substrate 620 of the working electrode 608 establishes a surface at which a catalyst arrangement of the electrode 608 is provided. The catalyst arrangement includes a conductive projection (e.g., nanowire)-nanoparticle architecture as described below.

The electrode 608 includes an array of nanowires 622 and/or other conductive projections supported by the substrate 620. Each nanowire 622 extends outward from the surface of the substrate 620. The nanowires 622 may thus be oriented in parallel with one another. Each nanowire 622 has a semiconductor composition for catalytic conversion of carbon dioxide (CO₂) in the chemical cell 602 into, e.g., formic acid. In some cases, the semiconductor composition includes gallium nitride (GaN). Additional or alternative semiconductor materials may be used, including, for instance, indium nitride, indium gallium nitride, aluminum nitride, boron nitride, aluminum oxide, silicon, and/or their alloys.

The nanowires 622 may facilitate the conversion in one or more ways. For instance, each nanowire 622 may be configured to extract the charge carriers (e.g., electrons) generated in the substrate 620. The extraction brings the electrons to external sites along the nanowires 622 for use in the CO₂ reduction. The composition of the nanowires 622 may also form an interface well-suited for reduction of CO₂, as explained below.

Each nanowire 622 may be or include a columnar, post-shaped, or other elongated structure that extends outward (e.g., upward) from the plane of the substrate 620. The nanowires 622 may be grown or formed as described in U.S. Pat. No. 8,563,395, the entire disclosure of which is hereby incorporated by reference. The dimensions, size, shape, composition, and other characteristics of the nanowires 622 (and/or other conductive projections) may vary. For instance, each nanowire 622 may or may not be elongated like a nanowire. Thus, other types and shapes of nanostructures or other conductive projections from the substrate 620, such as various shaped nanocrystals, may be used.

In some cases, one or more of the nanowires 622 is configured to generate electron-hole pairs upon illumination. For instance, the nanowires 622 may be configured to absorb light at frequencies different than other light absorbing components of the electrode 608. For example, one light absorbing component, such as the substrate 620, may be configured for absorption in the visible or infrared wavelength ranges, while another component may be configured to absorb light at ultraviolet wavelengths. In other cases, the nanowires 622 are the only light absorbing component of the electrode 608.

The electrode 608 further includes nanoparticles 624 disposed over the array of nanowires 622. Each nanoparticle 624 is configured for the catalytic conversion of carbon dioxide (CO₂) in the chemical cell 602. A plurality of the nanoparticles 624 are disposed on each nanowire 622, as schematically shown in FIG. 6. The nanoparticles 624 are distributed across the outer surface of each nanowire 622. For example, each nanowire 622 has a plurality of the nanoparticles 624 distributed across or along sidewalls of the nanowire 622. The nanoparticles 624 may also be disposed on a top or upper surface of each nanowire 622. The distribution may not be uniform or symmetric as shown. As described herein, each nanoparticle 624 may include or be composed of a metal sulfide for the reduction of carbon dioxide (CO₂) in the chemical cell 602.

The metal sulfide may be or include copper sulfide. In some cases, the copper sulfide is CuS. Alternative or additional compositions may be used. Alternative or additional metal sulfides having a d-block metal element may be used, including, for instance, silver sulfide (AgS), gold sulfide (AuS), and zinc sulfide (ZnS). The use of alternative or additional metals and/or metal sulfides may lead to alternative or additional reduction products of the CO₂ conversion. In some cases, additional nanoparticles may be used, including nanoparticles composed of, or otherwise including one or more noble metals, such as gold.

The nanoparticles 624 may be sized in a manner to facilitate the CO₂ reduction. The size of the nanoparticles 624 may be useful in catalyzing the reaction, as described herein. The size of the nanoparticles 624 may be promote the CO₂ reduction in additional or alternative ways. For instance, the nanoparticles 624 may also be sized to avoid inhibiting the illumination of the light absorber (e.g. the substrate 620).

The manner in, or extent to, which the array of nanowires 622 is ordered may vary. In some cases, the nanowires 622 may be arranged laterally in a regular or semi-regular pattern. In other cases, the lateral arrangement of the nanowires 622 is irregular. In such cases, the ordered nature of the nanowires 622 is instead limited to the parallel orientation of the nanowires 622.

In some cases, each nanowire 622 is coated with the nanoparticles 624. The extent of the coating may vary. For instance, a top surface of each nanowire 622 may be entirely coated with the nanoparticles 624, while one or more portions of the sidewalls of the nanowires 622 may be partially coated. The distribution of the nanoparticles 624 may accordingly be uniform or non-uniform. The nanoparticles 624 may thus be distributed randomly across each nanowire 622. The schematic arrangement of FIG. 6 is shown for ease in illustration.

The nanowires 622 and the nanoparticles 624 are not shown to scale in the schematic depiction of FIG. 6. The shape of the nanowires 622 and the nanoparticles 624 may also vary from the example shown.

FIG. 7 depicts a method 700 of fabricating an electrode of an electrochemical system in accordance with one example. The method 700 may be used to manufacture any of the working electrodes described herein or another electrode or device. The method 700 may include additional, fewer, or alternative acts. For instance, the method 700 may or may not include one or more acts directed to fabricating a substrate (act 404).

The method 400 may begin with an act 402 in which a substrate is prepared. The substrate may be or be formed from a p-n Si wafer. In one example, a 2-inch Si wafer was used, but other (e.g., larger) size wafers may be used. Other semiconductors and substrates may be used. Preparation of the substrate may include one or more thermal diffusion procedures.

The act 702 may include an act 704 in which the substrate is doped. Thermal diffusion and/or other procedures may be used. The doping may be directed to forming a junction. The substrate may accordingly be doped with p-type dopant(s) and n-type dopant(s). An act 706 may then be implemented to anneal the substrate.

In some cases, an n⁺-p silicon junction of the substrate is formed through a standard thermal diffusion process using, e.g., a (100) silicon wafer. For instance, phosphorus and boron as n-type and p-type dopants, respectively, may be deposited on the front and back sides of the polished p-Si (100) wafer by spin-coating, but other dopants may be used. The wafer may then be annealed, e.g., at 950 degrees Celsius under nitrogen atmosphere for four hours. The process parameters may vary in other cases. For instance, the wafer may be annealed at 900 degrees Celsius under argon atmosphere.

In the example of FIG. 4, the method 400 includes an act 708 in which GaN or other nanowire arrays (or other conductive projections) are grown or otherwise formed on the substrate. Each nanowire (or other conductive projection) has a semiconductor composition as described herein. The nanowire growth may be achieved in an act 710 in which plasma-assisted molecular beam epitaxy (MBE) is implemented. The growth may be implemented under nitrogen-rich conditions in accordance with an act 712.

In one example, plasma-assisted MBE was used for growing GaN nanowires on silicon wafer under nitrogen-rich conditions to promote the formation of a N-terminated surface to protect against photocorrosion and oxidation. The substrate temperature was 790° C. and the growth duration was about 2 hours. The forward plasma power was 350 W with a Ga flux beam equivalent pressure (BEP) of 5×10⁻⁸ Torr.

The growth parameters may vary in other cases. For instance, in another example, the growth conditions were as follows: a growth temperature of 790° C. for 1.5 hours, a Ga beam equivalent pressure of about 6×10⁻⁸ Torr, a nitrogen flow rate of 1 standard cubic centimeter per minute (sccm), and a plasma power of 350 Watts. The substrate and the nanowires provide or act as scaffolding for the catalysts deposited in the following steps.

In an act 714, nanoparticles are deposited across each nanowire or other conductive projection. In one example, nanoparticles were deposited on GaN nanowires by a thermal evaporation procedure in an act 716. The nanoparticles may be deposited in a surface normal direction in accordance with an act 718. In one example, a deposition rate of 0.1 nm/s was used under a base pressure of 1×10⁻⁶ Torr, but the process parameters may vary. Other types of deposition procedures may be used, including, for instance, electron beam deposition.

At this stage of the method 700, each nanoparticle has a metallic composition. For instance, the nanoparticles may be composed of, or otherwise include, Cu. Additional or alternative d-block metals may be included in the metallic composition, including, for instance, Ag, Au, Zn, and combinations thereof.

The method 700 includes an act 720 in which an electrochemical procedure is implemented to transform the metallic composition of the nanoparticles such that each nanoparticle of the plurality of nanoparticles is composed of, or otherwise includes, a metal sulfide. The electrochemical procedure immerses the nanowires in an electrolyte (e.g., KHCO₃) that includes hydrogen sulfide (H₂S) for the transformation. In some cases, the act 720 includes an act 722 in which a photochemical reduction reaction is conducted as the electrochemical procedure.

The act 720 may alternatively or additionally include an act 724 in which H₂S is dissolved in the electrolyte. In some cases, a CO₂ mixture including one or more impurities is used. One of the impurities may be H₂S as described herein.

In one example of the spontaneous transformation of Cu nanoparticles to CuS nanoparticles, a photoelectrochemical CO₂ reduction reaction was conducted in a CO₂ mixture gas-purged electrolyte at reductive potential under light illumination (100 mW/cm²). The electrolyte used for the electrochemical measurements was an aqueous solution of 0.1 M KHCO₃ (Sigma-Aldrich, 99.95%) prepared by dissolving the solid salt in deionized water. The electrolyte was purged with two gases of CO₂ (99.99%) and H₂S (300 ppm of H₂S and 99.97% N₂) until the electrolyte was saturated. The CO₂+H₂S-purged electrolyte had a pH value of 7.5, which is higher than CO₂-purged 0.1 M KHCO₃ electrolyte (pH=6.8).

The nature of the electrochemical procedure may vary from the examples described above in one or more ways. For instance, the composition of the electrolyte and/or the gas mixture may vary.

Examples of photocathodes and other devices including metal sulfide (e.g., CuS) decorated conductive projections (e.g., GaN nanowires) integrated on a substrate, e.g., planar silicon (Si), for the conversion of H₂S-containing CO₂ mixture gas to HCOOH have been described. H₂S impurity in industrial CO₂ gas leads to the spontaneous transformation of Cu to CuS nanoparticles, which results in significantly increased faradaic efficiency of HCOOH generation. The CuS/GaN/Si photocathode exhibited superior faradaic efficiency of HCOOH=70.2% and partial current density=7.07 mA/cm² at a bias voltage of −1.0 V_{RHE} under AM1.5G one-sun illumination. The impurity mixed in the CO₂ gas enhances, rather than degrades, the performance of the PEC CO₂ reduction reaction.

The term “about” is used herein to include deviations from a specified value that are effectively the same as the specified value, including, for instance, deviations that do not result in a detectable or discernable change in outcome.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. A device for catalytic conversion of carbon dioxide (CO₂), the device comprising:
a substrate having a surface;
an array of conductive projections supported by the substrate and extending outward from the surface of the substrate, each conductive projection of the array of conductive projections having a semiconductor composition; and
a plurality of nanoparticles disposed over the array of conductive projections, each nanoparticle of the plurality of nanoparticles being configured for the catalytic conversion of carbon dioxide (CO₂);
wherein each nanoparticle of the plurality of nanoparticles comprises a metal sulfide, the metal sulfide comprising a d-block metal.

2. The device of claim 1, wherein the metal sulfide comprises copper sulfide.

3. The device of claim 1, wherein the metal sulfide is selected from the group consisting of copper sulfide, silver sulfide, gold sulfide, zinc sulfide, and combinations thereof.

4. The device of claim 1, wherein each conductive projection of the array of conductive projections is coated with respective nanoparticles of the plurality of nanoparticles.

5. The device of claim 4, wherein the respective nanoparticles of the plurality of nanoparticles do not uniformly cover each conductive projection of the array of conductive projections.

6. The device of claim 1, wherein:
the substrate comprises a semiconductor material; and
the semiconductor material is doped to define a junction to generate charge carriers upon absorption of solar radiation.

7. The device of claim 6, wherein each conductive projection of the array of conductive projections comprises a nanowire configured to extract the charge carriers generated in the substrate.

8. The device of claim 1, wherein the substrate comprises silicon.

9. The device of claim 1, wherein the semiconductor composition comprises gallium nitride.

10. The device of claim 1, wherein the catalytic conversion occurs in a thermochemical cell.

11. An electrochemical system comprising a working electrode configured in accordance with the device of claim 1, and further comprising:
a counter electrode;
an electrolyte in which the working and counter electrodes are immersed; and
a voltage source that applies a bias voltage between the working and counter electrodes;
wherein the bias voltage is set to a level for conversion of CO₂ into formic acid at the working electrode.

12. The electrochemical system of claim 11, wherein the electrolyte comprises hydrogen sulfide (H₂S).

13. A photocathode for a photoelectrochemical cell, the photocathode comprising:
a substrate comprising a semiconductor material, the semiconductor material being doped to generate charge carriers upon solar illumination;
an array of nanowires supported by the substrate, each nanowire of the array of nanowires being configured to extract the charge carriers from the substrate, each nanowire of the array of nanowires comprising gallium nitride; and
a plurality of nanoparticles distributed across each nanowire of the array of nanowires, each nanoparticle of the plurality of nanoparticles being configured for the catalytic conversion of carbon dioxide (CO₂) in the photoelectrochemical cell into formic acid;
wherein each nanoparticle of the plurality of nanoparticles comprises a metal sulfide, the metal sulfide comprising a d-block metal.

14. The photocathode of claim 13, wherein the metal sulfide comprises copper sulfide.

15. A photoelectrochemical system comprising a working photocathode configured in accordance with the photocathode of claim 13, and further comprising:
a counter electrode;
an electrolyte in which the working photocathode and the counter electrode are immersed; and
a voltage source that applies a bias voltage between the working photocathode and the counter electrode;
wherein the bias voltage is set to a level for conversion of CO₂ into formic acid at the working photocathode.

16. The electrochemical system of claim 15, wherein the electrolyte comprises hydrogen sulfide (H₂S).

17. A method of fabricating a device for catalytic conversion of carbon dioxide (CO₂), the method comprising:
growing an array of conductive projections on a semiconductor substrate, each conductive projection of the array of conductive projections having a semiconductor composition;
depositing a plurality of nanoparticles across each conductive projection of the array of conductive projections, each nanoparticle of the plurality of nanoparticles having a metallic composition for the catalytic conversion of carbon dioxide (CO₂), the metallic composition comprising a d-block metal; and
implementing an electrochemical procedure that immerses the array of conductive projections in an electrolyte comprising hydrogen sulfide (H₂S) to transform the metallic composition of each nanoparticle of the plurality of nanoparticles such that each nanoparticle of the plurality of nanoparticles comprises a metal sulfide.

18. The method of claim 17, wherein the electrolyte further comprises carbon dioxide (CO₂).

19. The method of claim 17, wherein forming the array of conductive projections comprises growing an array of nanowires on the semiconductor substrate, each nanowire of the array of nanowires having a semiconductor composition for the catalytic conversion of carbon dioxide (CO₂).

20. The method of claim 19, wherein growing the array of nanowires comprises implementing a molecular beam epitaxy (MBE) procedure under nitrogen-rich conditions.

21. The method of claim 17, wherein depositing the plurality of nanoparticles comprises implementing a thermal evaporation procedure to deposit copper nanoparticles on the array of conductive projections.

22. The method of claim 17, wherein implementing the electrochemical procedure comprises conducting a photoelectrochemical CO₂ reduction reaction.

23. The method of claim 17, wherein implementing the electrochemical procedure comprises dissolving carbon dioxide (CO₂) and hydrogen sulfide (H₂S) into a KHCO₃ electrolyte.

24. The method of claim 17, wherein the metallic composition comprises copper such that the metal sulfide comprises copper sulfide.
